(19) United States
(12) Patent Application Publication
(10) Pub. No.: US 2025/0175823 A1
(43) Pub. Date: May 29, 2025

(54) METHODS AND APPARATUSES FOR SENSING AREA IDENTIFICATION

(71) Applicant: LENOVO (BEIJING) LIMITED, Beijing (CN)

(72) Inventors: Jianfeng WANG, Beijing (CN); Lianhai WU, Beijing (CN); Tingfang TANG, Beijing (CN); Bingchao LIU, Beijing (CN)

(21) Appl. No.: 18/841,123

(22) PCT Filed: Feb. 25, 2022
(86) PCT No.: PCT/CN2022/078007

§ 371 Date: Aug. 23, 2024

(51) Int. Cl. H04W 24/08; H04W 4/02

(52) U.S. Cl. CPC H04W 24/08; H04W 4/02

(57) ABSTRACT

Embodiments of the present disclosure relate to methods and apparatuses for sensing area identification. According to an embodiment of the present disclosure, a network entity may include: a receiver configured to: receive a sensing service request which includes a sensing area indication indicating a sensing area and quality of service (QOS) requirement(s); and a processor coupled to the receiver and configured to: identify, based on the sensing area indication, the QoS requirement(s) and cell-related information, at least one cell for performing a sensing operation; and a transmitter coupled to the processor.

### TECHNICAL FIELD

Embodiments of the present application are related to wireless communication technology, and more particularly, related to methods and apparatuses for sensing area identification.

### BACKGROUND

Radio sensing (also referred to as wireless sensing) may refer to using the radio information obtained during signal processing to detect environmental changes caused by characteristics of objects (e.g., vehicles) and/or people. Radio sensing may be used in various scenarios, e.g., safe autonomous vehicles or unmanned aerial vehicle (UAV), environment mapping to improve positioning accuracy and enable environment related applications and real-time monitoring for intrusion detection, etc.

Introducing sensing capability into cellular wireless communication system has the benefit of sharing the same spectrum and infrastructure, especially on the industry with both communication and sensing, which is one of the promising techniques in next generation networks, e.g., 3rd generation partnership project (3GPP) new radio (NR) Rel-19 and beyond. In the radio sensing technique, a BS associated with a sensing area may transmit, receive, and process sensing signals for an object in the sensing area. Currently, details regarding sensing area identification need to be further discussed in 3GPP 5G technology.

### SUMMARY OF THE APPLICATION

Embodiments of the present application at least provide a technical solution for sensing area identification.

According to some embodiments of the present application, a network entity may include: a receiver configured to: receive a sensing service request which includes a sensing area indication indicating a sensing area and quality of service (QOS) requirement(s) to perform a sensing operation; and a processor coupled to the receiver and configured to: identify, based on the sensing area indication, the QoS requirement(s) and cell-related information, at least one cell for performing the sensing operation; and a transmitter coupled to the processor.

In some embodiments of the present application, the sensing area indication indicates information to describe the sensing area to be sensed.

In some embodiments of the present application, the sensing area indication at least includes a location of the sensing area and a range of the sensing area.

In some embodiments of the present application, the transmitter is configured to transmit, to an access and mobility management function (AMF), a request message to request the cell-related information, wherein the request message includes: a location of the sensing area; and a number of candidate cells associated with the sensing area; and wherein the receiver is further configured to receive, from the AMF, the cell-related information, wherein the cell-related information includes: a cell identity (ID) of each cell of the number of candidate cells; and a distance between each cell of the number of candidate cells and the location of the sensing area.

In some embodiments of the present application, the processor is further configured to identify the at least one cell from the number of candidate cells based on the sensing area indication, the QoS requirement(s), and the cell-related information.

In some embodiments of the present application, the transmitter is configured to transmit, to a location management function (LMF), a request message to request the cell-related information, wherein the request message includes: a location of the sensing area; and a number of candidate cells associated with the sensing area; and wherein the receiver is further configured to receive, from the LMF, the cell-related information, wherein the cell-related information includes: a cell ID of each cell of the number of candidate cells; and a distance between each cell of the number of candidate cells and the location of the sensing area.

In some embodiments of the present application, the processor is further configured to identify the at least one cell from the number of candidate cells based on the sensing area indication, the QoS requirement(s), and the cell-related information.

In some embodiments of the present application, the cell-related information is stored in the network entity, and the cell-related information includes cell identities of one or more cells and positions of the one or more cells.

In some embodiments of the present application, the transmitter is configured to transmit an indication to an AMF, wherein the indication includes a cell ID of the at least one cell and expected radio resources for performing the sensing operation.

In some embodiments of the present application, the receiver is further configured to receive sensing data from at least one base station (BS) in the at least one cell via a user plane function (UPF) or a network data analytics function (NWDAF), the processor is further configured to analyze the sensing data to generate a sensing result, and the transmitter is further configured to transmit the sensing result to an application function (AF).

In some embodiments of the present application, the transmitter is configured to transmit an indication to at least one BS in the at least one cell to trigger the sensing operation in the at least one cell.

In some embodiments of the present application, the sensing operation includes at least one of: sensing signal transmission, sensing signal reception, sensing signal pre-processing, or sensing data transmission.

In some embodiments of the present application, the network entity is a sensing function (SF).

In some embodiments of the present application, the network entity is an AMF.

According to some other embodiments of the present application, a method performed by a network entity may include: receiving a sensing service request which includes a sensing area indication indicating a sensing area and QoS requirement(s) to perform a sensing operation; and identifying, based on the sensing area indication, the QoS requirement(s), and cell-related information, at least one cell for performing the sensing operation.

In some embodiments of the present application, the sensing area indication indicates information to describe the sensing area to be sensed.

In some embodiments of the present application, the sensing area indication at least includes a location of the sensing area and a range of the sensing area.

In some embodiments of the present application, the method may further includes: transmitting, to an AMF, a request message to request the cell-related information, wherein the request message includes: a location of the sensing area; and a number of candidate cells associated with the sensing area; and receiving, from the AMF, the cell-related information, wherein the cell-related information includes: a cell ID of each cell of the number of candidate cells; and a distance between each cell of the number of candidate cells and the location of the sensing area.

In some embodiments of the present application, the method may further includes identifying the at least one cell from the number of candidate cells based on the sensing area indication, the QoS requirement(s), and the cell-related information.

In some embodiments of the present application, the method may further includes: transmitting, to an LMF, a request message to request the cell-related information, wherein the request message includes: a location of the sensing area; and a number of candidate cells associated with the sensing area; and receiving, from the LMF, the cell-related information, wherein the cell-related information includes: a cell ID of each cell of the number of candidate cells; and a distance between each cell of the number of candidate cells and the location of the sensing area.

In some embodiments of the present application, the method may further includes identifying the at least one cell from the number of candidate cells based on the sensing area indication, the QoS requirement(s), and the cell-related information.

In some embodiments of the present application, the cell-related information is stored in the network entity, and the cell-related information includes cell identities of one or more cells and positions of the one or more cells.

In some embodiments of the present application, the method may further includes transmitting, an indication to an AMF, wherein the indication includes a cell ID of the at least one cell and expected radio resources for performing the sensing operation.

In some embodiments of the present application, the method may further include: receiving sensing data from at least one BS in the at least one cell via a UPF or a NWDAF, analyzing the sensing data to generate a sensing result, and transmitting the sensing result to an AF.

In some embodiments of the present application, the method may further includes transmitting an indication to at least one BS in the at least one cell to trigger the sensing operations in the at least one cell.

In some embodiments of the present application, the sensing operations includes at least one of: sensing signal transmission, sensing signal reception, sensing signal pre-processing, or sensing data transmission.

In some embodiments of the present application, the network entity is a SF.

In some embodiments of the present application, the network entity is an AMF.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates exemplary three levels of areas according to some embodiments of the present application;

FIG. 3 illustrates exemplary two kinds of sensing areas according to some embodiments of the present application;

FIG. 4 illustrates an exemplary sensing related procedure with SF according to some embodiments of the present application;

FIG. 5 illustrates a flowchart of an exemplary method for sensing area identification according to some embodiments of the present application;

FIG. 6 illustrates an exemplary sensing area according to some embodiments of the present application;

FIG. 7 illustrates a flowchart of another exemplary method for sensing area identification according to some other embodiments of the present application;

FIG. 8 illustrates a flowchart of another exemplary method for sensing area identification according to some other embodiments of the present application;

FIG. 9 illustrates a flowchart of another exemplary method for sensing area identification according to some other embodiments of the present application;

FIG. 10 illustrates a flowchart of another exemplary method for sensing area identification according to some other embodiments of the present application; and

FIG. 11 illustrates a simplified block diagram of an exemplary apparatus for sensing area identification according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

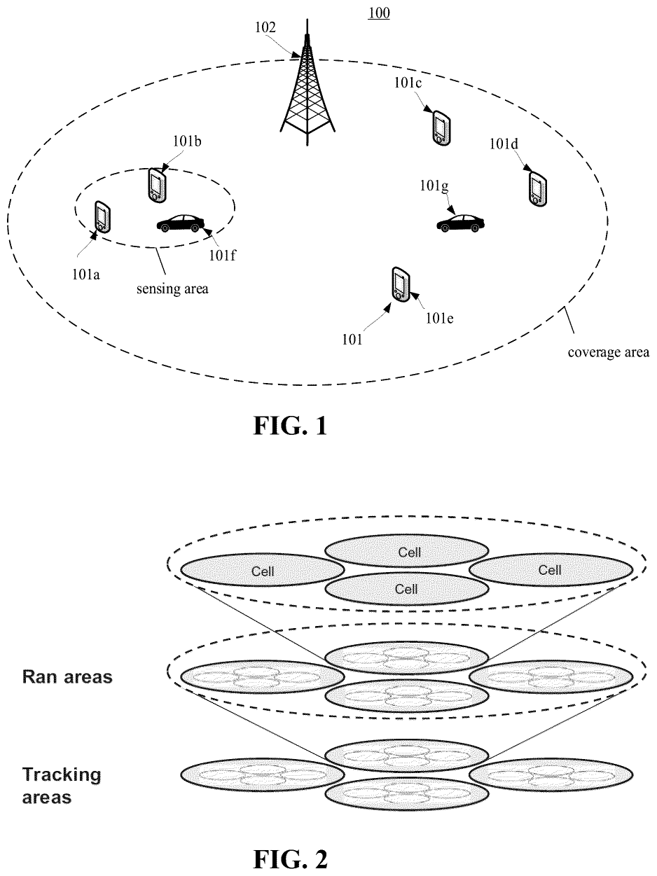

FIG. 1 illustrates an exemplary wireless communication system 100 in accordance with some embodiments of the present application.

As shown in FIG. 1, the wireless communication system 100 includes at least one user equipment (UE) 101 and at least one BS 102. In particular, the wireless communication system 100 includes seven UEs 101 (e.g., UE 101a-UE 101g) and one BS 102 for illustrative purpose. Although a specific number of UEs 101 and BS 102 are depicted in FIG. 1, it is contemplated that any number of UEs 101 and BSs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 102 may also be referred to as an access point, an access terminal, a base, a macro cell, a node-B, an enhanced node B (eNB), a gNB, a home node-B, a relay node, or a device, or described using other terminology used in the art. The BS 102 is generally part of a radio access network that may include a controller communicably coupled to the BS 102.

According to some other embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

All the UE 101a-UE 101g in the embodiments of FIG. 1 are in a coverage area of the BS 102, and may transmit information or data to the BS 102 and receive control information or data from the BS 102, for example, via LTE or NR Uu interface. In the embodiments of FIG. 1, UEs 101a-101e are portable wireless communication devices and UEs 101f-101g are VUEs (e.g., cars).

The BS in FIG. 1 may be introduced with a sensing capability. For example, the BS may sense UE 101f as a sensing target to acquire its position, speed, lane occupying, and/or around three-dimensional (3D) map in a sensing area. In order to acquire the above information, the BS serving the sensing area may transmit, receive, and process the sensing signals for the sensing target.

In current 5G system (5GS), three kinds of areas are defined, i.e., cell, radio access network (RAN) area, and tracking area. FIG. 2 illustrates exemplary three kinds of areas according to some embodiments of the present application.

Referring to FIG. 2, one or more cells (e.g., four cells) are grouped into a RAN area, wherein each RAN area is identified by an RAN area identifier (RAI). The one or more RAN areas (e.g., four RAN areas), in turn, are grouped into a tracking area, wherein each tracking area is identified by a tracking area identifier (TAI). Consequently, each cell belongs to a corresponding RAN area and a corresponding tracking area, and the identities of the corresponding RAN area and corresponding tracking area are included in cell system information associated with the cell.

In 5GS, a RAN area may be the basis for a UE tracking on RAN level. UEs in inactive state may be assigned a RAN notification area, which includes one of the followings: a list of cell identities (i.e., a cell group), a list of RAIs, or a list of TAIs. A tracking area may be the basis for UE tracking on core network (CN) level. Each UE in idle state is assigned a UE registration area by the CN, which includes a list of TAIs. The UE registration area may be an available area for CN, which is supposed to be much larger than the expected sensing area in practice.

Thus, in current 5GS, the areas are defined in different levels to efficiently find the UEs. For example, the registration area is assigned and updated for each serving UE, and the related BSs in the registration area may be triggered to page the target UEs. However, these areas (e.g., a cell, a RAN area, or a tracking area) are supposed to be much larger than the expected sensing area in practice and the sensing area would be more flexible than these areas.

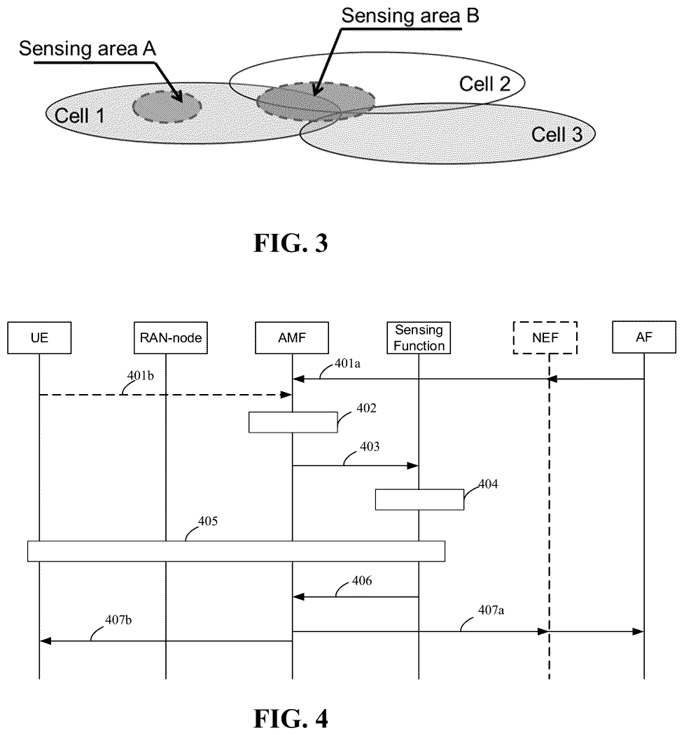

For example, FIG. 3 illustrates exemplary two kinds of sensing areas according to some embodiments of the present application.

Referring to FIG. 3, it illustrates two kinds of sensing areas (e.g., sensing area A and sensing area B) in the cell coverages of three cells (e.g., cell 1, cell 2, and cell 3). Sensing area A is fully covered by cell 1, so the sensing signals and procedures for sensing the sensing area A can be triggered in cell 1 only. For the sensing area B, although its center is in cell 1, its range is over the edges of three cells, so the sensing signals and procedures for sensing the sensing area B may be triggered in all of the three cells.

In some embodiments, a new 5G core network (5GC) entity (e.g., a SF) may be introduced in CN to perform sensing-related operations. For example, FIG. 4 illustrates an exemplary sensing related procedure with SF according to some embodiments of the present application.

In step 401a, an AF may transmit a sensing service request to an AMF, e.g., directly or via a network exposure function (NEF). Alternatively, in step 401b, a UE may transmit a sensing service request to the AMF. The sensing service request in step 401a or 401b may include at least one of: a target area ID, a UE ID, required QoS requirement(s). The “target Area” herein may refer to a RAN area or a tracking area as described above.

After receiving the sensing service request, in step 402, the AMF may select an SF based on some factors including required QoS requirement(s), sensing function capabilities, the load of the SF, etc.

In step 403, the AMF may transmit the sensing service request to the selected SF.

After receiving the sensing service request, in step 404, the SF may select the RAN-node (e.g., BS) and/or UE based on the target area ID and/or the UE ID and decides the sensing method to be used.

In step 405, the SF may perform sensing procedures with the RAN-node and/or the UE to collect sensing data and then obtain the sensing result based on the sensing signals.

In step 406, the SF may transmit a sensing service response to the AMF. The sensing service response may include the sensing result.

In the case that step 401a is performed, step 407a may be performed. In step 407a, the AMF may return a sensing service response to the AF, e.g., directly or via the NEF. In the case that step 401b is performed, step 407b may be performed. In step 407b, the AMF may return a sensing service response to the UE. The sensing service response in step 407a or 407b may include the sensing result.

As stated above, the target area used in FIG. 4 may be a RAN area or a tracking area. However, as illustrated in FIG. 3, the sensing area is much smaller than the cell, the RAN area, or the tracking area in practice and the sensing area would be much more flexible than these areas. Given this, using these areas as the sensing area is not accurate for a sensing service. Consequently, for a wireless network to integrate a sensing ability, how to identify a sensing area by a core network and how to identify the target cell(s) to transmit, receive, and process sensing signals for the sensing area need to be addressed.

Given the above, embodiments of the present application provide improved solutions for sensing area identification, which can at least identify a sensing area by the CN and identify the target cell(s) for performing the sensing operations for the sensing area, thereby well supporting the sensing ability in 3GPP NR release 19 and beyond. More details on embodiments of the present application will be illustrated in the following text in combination with the appended drawings.

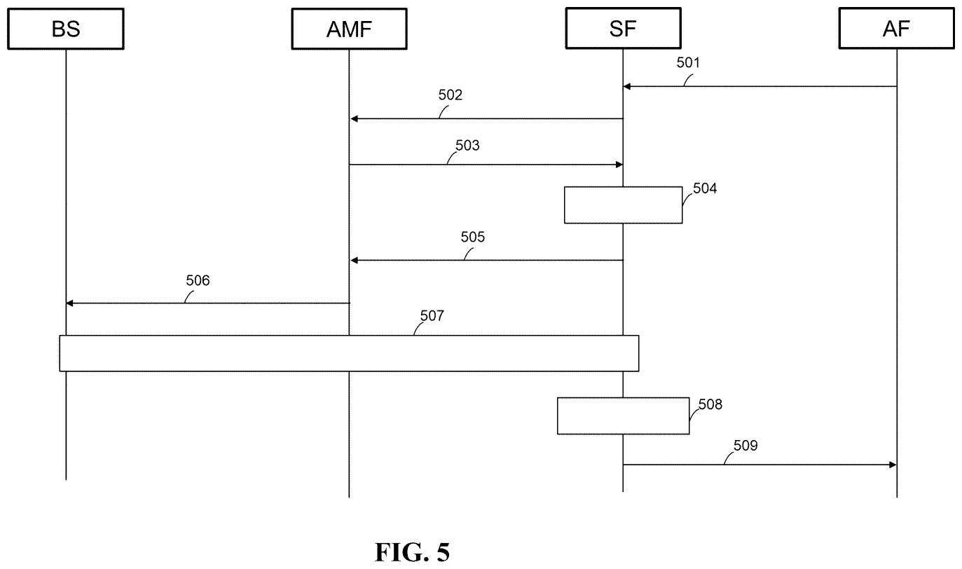

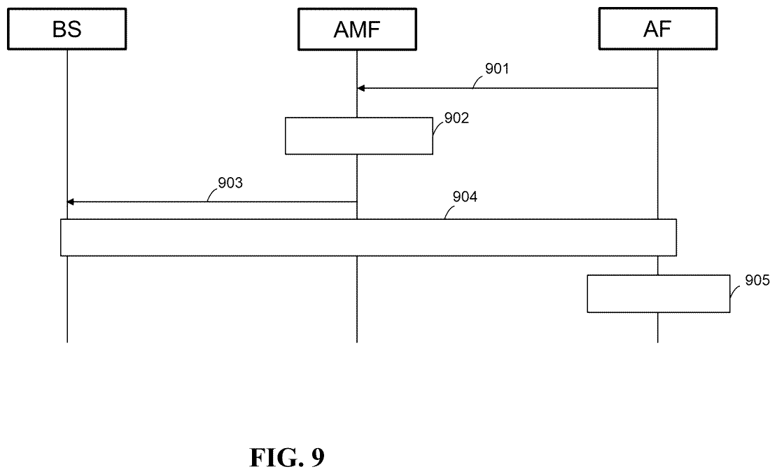

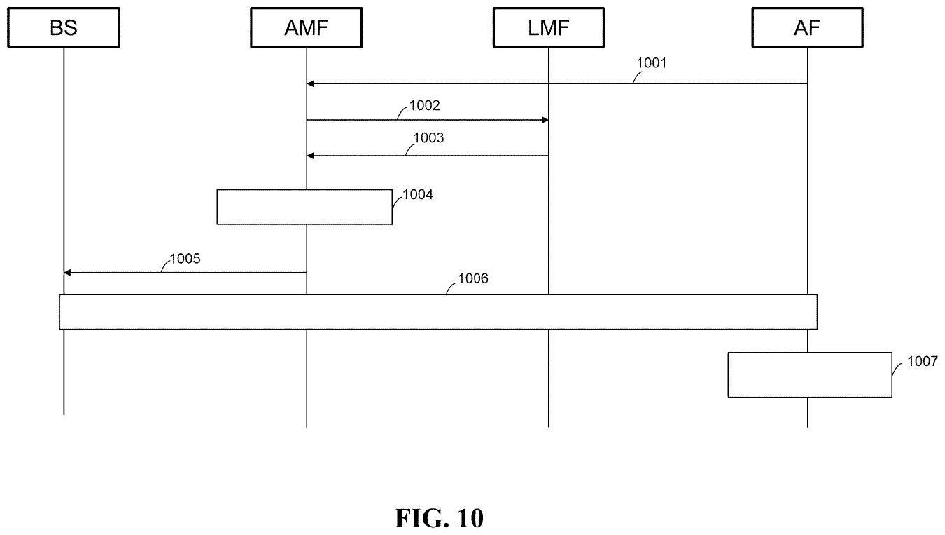

According to some embodiments of the present application, there are two kinds of solutions in CN to implement the sensing area identification and target cell(s) identification. One is to introduce a new function entity (e.g., the SF as stated above) to perform operations and procedures related to sensing area identification and target cell(s) identification, the other is to extend and enhance the current function entities (e.g., the AMF and the LMF) to perform operations and procedures related to sensing area identification and target cell(s) identification. Specifically, the following FIGS. 5, 7, and 8 illustrate the former solution (e.g., introducing a new function entity in CN) and FIGS. 9-10 illustrate the later solution (e.g., enhancing the current function entities).

FIG. 5 illustrates a flowchart of an exemplary method for sensing area identification according to some embodiments of the present application. The method illustrated in FIG. 5 may be performed by four network entities, e.g., AF, SF, AMF, and a BS (e.g., BS 102 as shown in FIG. 1), wherein the AF, SF, and AMF are three CN entities. Although the method is illustrated in a system level, persons skilled in the art can understand that the method implemented in the four network entities can be separately implemented and incorporated in other apparatus with the like functions.

As shown in FIG. 5, in step 501, the AF may transmit a sensing service request to the SF to perform a sensing operation. The sensing service request may include a sensing area indication indicating a sensing area and QoS requirement(s).

In some embodiments of the present application, the sensing area may be a two-dimensional (2D) area or 3D space.

In some embodiments of the present application, the sensing area indication may indicate information to describe the sensing area to be sensed. For example, the sensing area indication may indicate at least one of the following information: a name of a sensing area (e.g., a name of a street or a building), an address of the sensing area (e.g., an address of a street or a building), a location (e.g., physical location) of the sensing area, a range of the sensing area, or any other information which is associated with the sensing area. In an example of the present application, the location of the sensing area may be a location of the centre of the sensing area.

In some embodiments, the location of the sensing area may be represented by longitude and latitude values. In some other embodiments, the location of the sensing area may be represented by coordinate values (e.g., x value and y value) of a plane coordinate or coordinate values (e.g., x value, y value, and z value) of a space coordinate. In some other embodiments, the location of the sensing area may be represented by a distance and an angle related to a reference location. Persons skilled in the art can understand that these embodiments for representing the location of the sensing area are only for illustrative purpose, the location of the sensing area may be represented by any other information in some other embodiments of the present application.

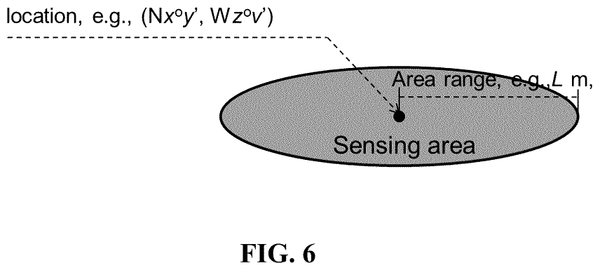

FIG. 6 illustrates an exemplary sensing area according to some embodiments of the present application. Referring to FIG. 6, the sensing area may be seen as a 2D circle area. In such embodiments, the sensing area indication may indicate a location of the centre of the sensing area (e.g., indicating the longitude and latitude values of the centre of the sensing area) and the range (e.g., in terms of meters) of the sensing area. In the example of FIG. 6, the longitude and latitude values of the centre of the sensing area may be (Nx°y′, Wz°v′) and the area range of the sensing area may be L m.

Referring to FIG. 5, the QoS requirement(s) included in the sensing service request may be the requirement(s) on the quality. In some embodiments, the QoS requirement(s) may be a set of accuracy requirements for the measured results. For example, the measure results may include at least one of: the presence of at least one target UE (e.g., vehicle), speed of at least one target UE, location of at least one target UE, or any other information of at least one target UE in the sensing area.

After receiving the sensing service request in step 501, in step 502, the SF may transmit a request message to request cell-related information to the AMF. The request message may include a location of the sensing area and a number of candidate cells associated with the sensing area.

The location of the sensing area may be determined based on the sensing area indication in step 501. As stated above, the location of the sensing area may be represented by longitude and latitude values, or represented by coordinate values (e.g., x value and y value) of a plane coordinate or coordinate values (e.g., x value, y value, and z value) of a space coordinate, or represented by a distance and an angle related to a reference location, or represented may any other information which can be used to indicate the location of the sensing area. In some embodiments of the present application, the location of the sensing area may be a location of the center of the sensing area (e.g., the longitude and latitude values of the center of the sensing area).

After receiving the request message in step 502, the AMF may determine the number of candidate cells. In some embodiments of the present application, the AMF may maintain cell identities of one or more cells and positions of the one or more cells, and determine the number of candidate cells from the one or more cells based on the distance between the one or more cells maintained by the AMF and the location of the sensing area. For example, the number of candidate cells may include cell(s) close to the sensing area. In some embodiments, the number of candidate cells may include cell(s) closest to the sensing area and zero or more cells around the sensing area.

After determining the number of candidate cells, in step 503, the AMF may transmit the cell-related information to the SF. The cell-related information may include: a cell ID of each cell of the number of candidate cells; and a distance between each cell of the number of candidate cells and the location of the sensing area.

After receiving the cell-related information from the AMF in step 503, in step 504, the SF may identify at least one cell for performing the sensing operation based on the sensing area indication, the QoS requirement(s), and the cell-related information. Specifically, the SF may identify the at least one cell from the number of candidate cells based on the sensing area indication, the QoS requirement(s), and the cell-related information. For example, the at least one cell may include cell(s) in the number of candidate cells which have small distances from the location of the sensing area. Alternatively or additionally, the at least one cell may include cell(s) in the number of candidate cells which better satisfy the QoS requirement(s). For example, in the case that the QoS requirement(s) require high accuracy of the measured results, the at least one cell may include cell(s) in the number of candidate cells which have more radio resources and/or have better signal quality.

After identifying the at least one cell for performing the sensing operations, in step 505, the SF may transmit an indication to an AMF, the indication may include a cell ID of the at least one cell determined in step 504. In some embodiments of the present application, the indication may also include expected radio resources for performing the sensing operations. The expected radio resources may be calculated by the SF based on the QoS requirement(s), and may include resources (e.g., resources in the time domain, resources in the frequency domain, etc.) for transmitting the sensing signals, power for transmitting the sensing signals, and/or any other information for transmitting the sensing signals.

After receiving the indication in step 505, in step 506, the AMF may transmit an indication to at least one BS in the at least cell indicated by the cell ID in step 505. Specifically, for each cell of the at least cell, the AMF may transmit an indication to a corresponding BS of the cell in step 506. Then, each BS of the at least one BS may perform step 507. For simplicity, embodiments of FIG. 5 illustrate one BS of the at least one BS as an example.

For example, the indication to a BS of the at least one BS in step 506 may indicate the BS to trigger the sensing operations in the cell of the BS. In some embodiments of the present application, the indication may also include the expected radio resources received in step 505.

After receiving the indication, in step 507, the BS may trigger the sensing operations in the cell of the BS. In some embodiments of the present application, the sensing operations may include at least one of: sensing signal transmission, sensing signal reception, sensing signal pre-processing, or sensing data transmission.

For example, in step 507, the BS may schedule radio resources to transmit and receive sensing signals. In some cases, the indication in step 506 includes the expected radio resources, then the radio resources scheduled by the BS may be based on (e.g., the same as) the expected radio resources.

Alternatively or additionally, in step 507, the BS may pre-process the sensing signals to obtain the sensing data, for example, the sensing data may include at least one of: channel state information (CSI), reference signal receiving power (RSRP), or other data generated based on the sensing signals.

Alternatively or additionally, in step 507, the BS may transmit the sensing data to the SF, e.g., via a UPF or a NWDAF.

Consequently, in step 507, the SF may receive sensing data from the at least one BS in the at least one cell, e.g., via the UPF or the NWDAF. Then, in step 508, the SF may analyze the sensing data to generate a sensing result. In some embodiments of the present application, the sensing data is analysed to obtain the sensing results according to mathematic model(s) and/or machine learning method(s). After that, in step 509, the SF may transmit the sensing result to the AF as a response to the sensing serving request in step 501.

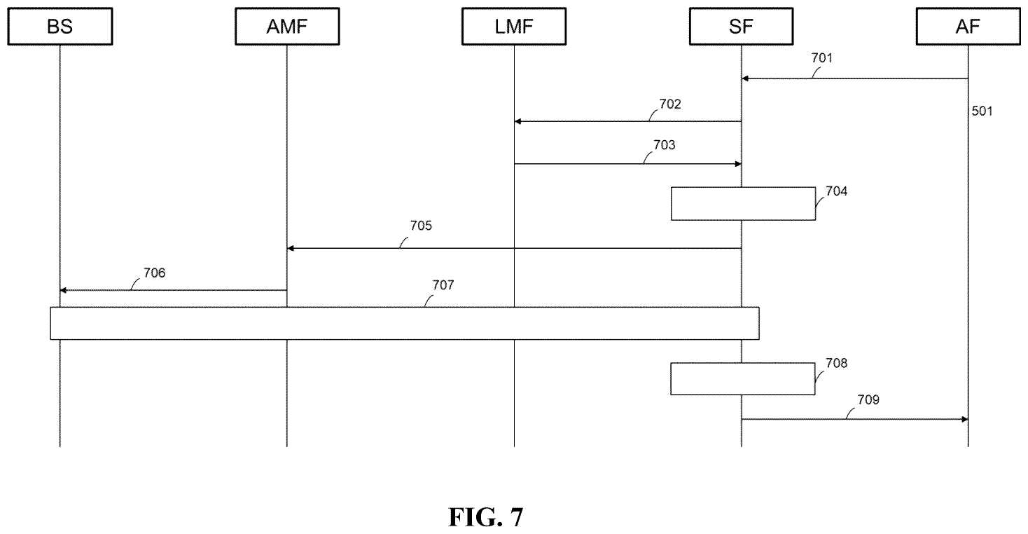

FIG. 7 illustrates a flowchart of another exemplary method for sensing area identification according to some other embodiments of the present application. The method illustrated in FIG. 7 may be performed by five network entities, e.g., AF, SF, AMF, LMF, and a BS (e.g., BS 102 as shown in FIG. 1), wherein the AF, SF, AMF, and LMF are four CN entities. Although the method is illustrated in a system level, persons skilled in the art can understand that the method implemented in the five network entities can be separately implemented and incorporated in other apparatus with the like functions.

As shown in FIG. 7, in step 701, the AF may transmit a sensing service request to the SF to perform a sensing operation. The sensing service request in step 701 may include the same content as that included in the sensing service request in step 501 in FIG. 5.

After receiving the sensing service request in step 701, in step 702, the SF may transmit a request message to request cell-related information to the LMF. The request message in step 702 may include the same content as that included in the request message in step 502 in FIG. 5.

After receiving the request message in step 702, the LMF may determine the number of candidate cells. In some embodiments of the present application, the LMF may maintain cell identities of one or more cells and positions of the one or more cells, and determine the number of candidate cells from the one or more cells based on the distance between the one or more cells maintained by the LMF and the location of the sensing area. For example, the number of candidate cells may include cell(s) close to the sensing area. In some embodiments, the number of candidate cells may include cell(s) closest to the sensing area and zero or more cells around the sensing area.

After determining the number of candidate cells, in step 703, the LMF may transmit the cell-related information to the SF. The cell-related information may include: a cell ID of each cell of the number of candidate cells; and a distance between each cell of the number of candidate cells and the location of the sensing area.

After receiving the cell-related information from the AMF in step 703, in step 704, the SF may identify at least one cell for performing the sensing operation based on the sensing area indication, the QoS requirement(s), and the cell-related information. The operation in step 704 may be the same as the operation in step 504 in FIG. 5.

Then, steps 705-709 may be performed. The operations in step 705-709 may be the same as steps 505-509 in FIG. 5, respectively.

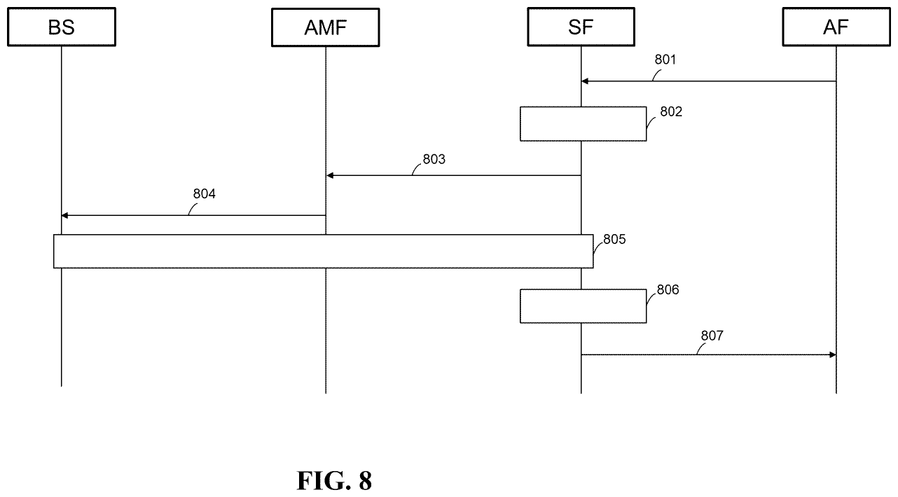

FIG. 8 illustrates a flowchart of another exemplary method for sensing area identification according to some other embodiments of the present application. The method illustrated in FIG. 8 may be performed by four network entities, e.g., AF, SF, AMF, and a BS (e.g., BS 102 as shown in FIG. 1), wherein the AF, SF, and AMF are three CN entities. Although the method is illustrated in a system level, persons skilled in the art can understand that the method implemented in the four network entities can be separately implemented and incorporated in other apparatus with the like functions.

As shown in FIG. 8, in step 801, the AF may transmit a sensing service request to the SF to perform a sensing operation. The sensing service request in step 801 may include the same content as that included in the sensing service request in step 501 in FIG. 5.

After receiving the sensing service request in step 801, in step 802, the SF may identify at least one cell for performing the sensing operation based on the sensing area indication, the QoS requirement(s), and cell-related information.

In the embodiments of FIG. 8, the cell-related information may be maintained (or stored) in the SF and may include cell identities of one or more cells and positions of the one or more cells. Thus, in step 802, the SF may identify the at least one cell from the one or more cells maintained in the SF based on the sensing area indication and the QoS requirement(s). For example, the at least one cell may include cell(s) in the one or more cells which have small distances between the position(s) of the cell(s) and the location of the sensing area. Alternatively or additionally, the at least one cell may include cell(s) in the number of candidate cells which better satisfy the QoS requirement(s). For example, in the case that the QoS requirement(s) require high accuracy of the measured results, the at least one cell may include cell(s) in the number of candidate cells which have more radio resources and/or have better signal quality.

After determining the at least one cell for performing the sensing operation, steps 803-807 may be performed. The operations in step 803-807 may be the same as steps 505-509 in FIG. 5, respectively.

Although FIGS. 5, 7, and 8 take the SF as an example to determine the at least one cell for performing the sensing operation, persons skilled in the art can understand the SF may be any other function which can perform the same operations as the SF in some other embodiments of the present application.

In some embodiments of the present application, the operations performed by the SF may be implemented by extending and enhancing the current AMF. For example, the following FIGS. 9 and 10 illustrate identifying the at least one cell for performing a sensing operation by the AMF.

FIG. 9 illustrates a flowchart of another exemplary method for sensing area identification according to some other embodiments of the present application. The method illustrated in FIG. 9 may be performed by three network entities, e.g., AF, AMF, and a BS (e.g., BS 102 as shown in FIG. 1), wherein the AF and AMF are two CN entities. Although the method is illustrated in a system level, persons skilled in the art can understand that the method implemented in the three network entities can be separately implemented and incorporated in other apparatus with the like functions.

As shown in FIG. 9, in step 901, the AF may transmit a sensing service request to the AMF to perform a sensing operation. The sensing service request in step 901 may include the same content as that included in the sensing service request in step 501 in FIG. 5.

After receiving the sensing service request in step 901, in step 902, the AMF may identify at least one cell for performing the sensing operations based on the sensing area indication, the QoS requirement(s), and cell-related information.

In the embodiments of FIG. 9, the cell-related information may be maintained (or stored) in the AMF and may include cell identities of one or more cells and positions of the one or more cells. Thus, in step 902, the AMF may identify the at least one cell from the one or more cells maintained in the AMF based on the sensing area indication and the QoS requirement(s). For example, the at least one cell may include cell(s) in the one or more cells which have small distances between the position(s) of the cell(s) and the location of the sensing area. Alternatively or additionally, the at least one cell may include cell(s) in the number of candidate cells which better satisfy the QoS requirement(s). For example, in the case that the QoS requirement(s) require high accuracy of the measured results, the at least one cell may include cell(s) in the number of candidate cells which have more radio resources and/or have better signal quality.

After identifying the at least one cell for performing the sensing operations, in step 903, the AMF may transmit an indication to at least one BS in the at least cell determined in step 902. Specifically, for each cell of the at least cell, the AMF may transmit an indication to a corresponding BS of the cell in step 903. Then, each BS of the at least one BS may perform step 904. For simplicity, embodiments of FIG. 9 illustrate one BS of the at least one BS as an example.

For example, the indication to a BS of the at least one BS in step 903 may indicate the BS to trigger the sensing operations in the cell of the BS. In some embodiments of the present application, the indication may also include radio resources to be used by the BS for transmitting and receiving the sensing signals.

After receiving the indication, in step 904, the BS may trigger the sensing operations in the cell of the BS. In some embodiments of the present application, the sensing operations may include at least one of: sensing signal transmission, sensing signal reception, sensing signal pre-processing, or sensing data transmission.

For example, in step 904, the BS may schedule radio resources to transmit and receive sensing signals. In some cases, the indication in step 903 includes radio resources, then the radio resources scheduled by the BS may be based on (e.g., the same as) the radio resources in step 903.

Alternatively or additionally, in step 904, the BS may pre-process the sensing signals to obtain the sensing data, for example, the sensing data may include at least one of: CSI, RSRP, or other data generated based on the sensing signals.

Alternatively or additionally, in step 904, the BS may transmit the sensing data to the AF, e.g., via a UPF or a NWDAF.

Consequently, in step 904, the AF may receive sensing data from the at least one BS in the at least one cell, e.g., via the UPF or the NWDAF. Then, in step 905, the AF may analyze the sensing data to generate a sensing result. In some embodiments of the present application, the sensing data are analysed to obtain the sensing results according to mathematic model(s) and/or machine learning method(s).

FIG. 10 illustrates a flowchart of another exemplary method for sensing area identification according to some other embodiments of the present application. The method illustrated in FIG. 10 may be performed by four network entities, e.g., AF, AMF, LMF, and a BS (e.g., BS 102 as shown in FIG. 1), wherein the AF, AMF, and LMF are three CN entities. Although the method is illustrated in a system level, persons skilled in the art can understand that the method implemented in the four network entities can be separately implemented and incorporated in other apparatus with the like functions.

As shown in FIG. 10, in step 1001, the AF may transmit a sensing service request to the AMF to perform a sensing operation. The sensing service request in step 1001 may include the same content as that included in the sensing service request in step 501 in FIG. 5.

After receiving the sensing service request in step 1001, in step 1002, the AMF may transmit a request message to request cell-related information to the LMF. The request message in step 1002 may include the same content as that included in the request message in step 502 in FIG. 5.

After receiving the request message in step 1002, the LMF may determine the number of candidate cells. In some embodiments of the present application, the LMF may maintain cell identities of one or more cells and positions of the one or more cells, and determine the number of candidate cells from the one or more cells based on the distance between the one or more cells maintained by the LMF and the location of the sensing area. For example, the number of candidate cells may include cell(s) close to the sensing area. In some embodiments, the number of candidate cells may include cell(s) closest to the sensing area and zero or more cells around the sensing area.

After determining the number of candidate cells, in step 1003, the LMF may transmit the cell-related information to the AMF. The cell-related information may include: a cell ID of each cell of the number of candidate cells; and a distance between each cell of the number of candidate cells and the location of the sensing area.

After receiving the cell-related information from the LMF in step 1003, in step 1004, the AMF may identify at least one cell for performing the sensing operations based on the sensing area indication, the QoS requirement(s), and the cell-related information. The operations in step 1004 may be the same as the operations in step 504 in FIG. 5.

Then, steps 1005-1007 may be performed. The operations in step 1005-1007 may be the same as steps 903-905 in FIG. 9, respectively.

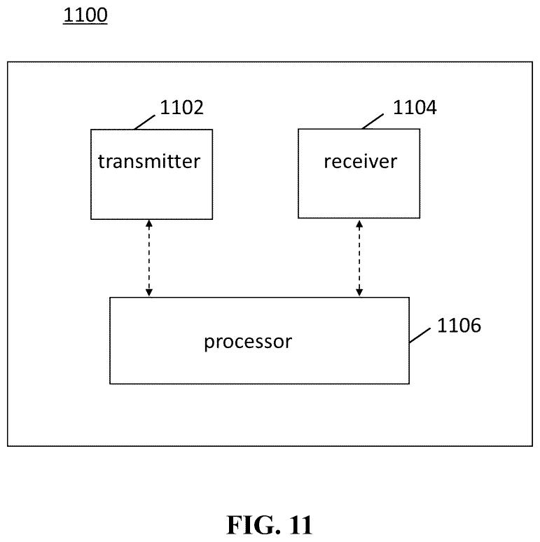

FIG. 11 illustrates a simplified block diagram of an exemplary apparatus 1100 for sensing area identification according to some embodiments of the present application. In some embodiments, the apparatus 1100 may be or include at least part of a network entity in FIGS. 5-10. For example, the apparatus 1100 may be or include at least part of the BS, the AF, the SF, the LMF, or the AMF in FIGS. 5-10.

Referring to FIG. 11, the apparatus 1100 may include at least one transmitter 1102, at least one receiver 1104, and at least one processor 1106. The at least one transmitter 1102 is coupled to the at least one processor 1106, and the at least one receiver 1104 is coupled to the at least one processor 1106.

Although in this figure, elements such as the transmitter 1102, the receiver 1104, and the processor 1106 are illustrated in the singular, the plural is contemplated unless a limitation to the singular is explicitly stated. In some embodiments of the present application, the transmitter 1102 and the receiver 1104 may be combined to one device, such as a transceiver. In some embodiments of the present application, the apparatus 1100 may further include an input device, a memory, and/or other components. The transmitter 1102, the receiver 1104, and the processor 1106 may be configured to perform any of the methods described herein (e.g., the method described with respect to FIGS. 5-10).

According to some embodiments of the present application, the apparatus 1100 may be an SF, and the transmitter 1102, the receiver 1104, and the processor 1106 may be configured to perform operations of the method as described with respect to FIGS. 5-8. For example, the receiver 1104 may be configured to: receive a sensing service request which includes a sensing area indication indicating a sensing area and QoS requirement(s). The processor 1106 may be configured to identify, based on the sensing area indication, and the QoS requirement(s) and the cell-related information, at least one cell for performing a sensing operation. In an embodiment, the transmitter 1102 may be configured to transmit an indication to an AMF, wherein the indication includes a cell ID of the at least one cell and expected radio resources for performing the sensing operation.

According to some embodiments of the present application, the apparatus 1100 may be an AMF, and the transmitter 1102, the receiver 1104, and the processor 1106 may be configured to perform operations of the method as described with respect to FIGS. 6, 9, and 10. For example, the receiver 1104 may be configured to: receive a sensing service request which includes a sensing area indication indicating a sensing area and QoS requirement(s). The processor 1106 may be configured to identify, based on the sensing area indication, and the QoS requirement(s) and the cell-related information, at least one cell for performing a sensing operation. In an embodiment, the transmitter 1102 may be configured to an indication to at least one BS in the at least one cell to trigger the sensing operation in the at least one cell.

In some embodiments of the present application, the apparatus 1100 may further include at least one non-transitory computer-readable medium. In some embodiments of the present application, the non-transitory computer-readable medium may have stored thereon computer-executable instructions to cause the processor 1106 to implement any of the methods as described above. For example, the computer-executable instructions, when executed, may cause the processor 1106 to interact with the transmitter 1102 and/or the receiver 1104, so as to perform operations of the methods, e.g., as described with respect to FIGS. 5-10.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for sensing area identification, including a processor and a memory. Computer programmable instructions for implementing a method for sensing area identification are stored in the memory, and the processor is configured to perform the computer programmable instructions to implement the method for sensing area identification. The method for sensing area identification may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for sensing area identification according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A network entity, comprising:
at least one memory; and
at least one processor coupled with the at least one memory and configured to cause the network entity to:
receive a sensing service request, which includes a sensing area indication indicating a sensing area and quality of service (QOS) requirements, to perform a sensing operation; and
identify, based on the sensing area indication, the QoS requirements and cell-related information, at least one cell for performing the sensing operation.

2. The network entity of claim 1, wherein the sensing area indication indicates information to describe the sensing area to be sensed.

3. The network entity of claim 1, wherein the sensing area indication includes at least a location of the sensing area and a range of the sensing area.

4. The network entity of claim 1,
wherein the at least one processor is further configured to cause the network entity to: transmit, to an access and mobility management function (AMF), a request message to request the cell-related information, wherein the request message includes:
a location of the sensing area; and
a number of candidate cells associated with the sensing area; and
receive, from the AMF, the cell-related information, wherein the cell-related information includes:
a cell identity (ID) of each cell of the number of candidate cells; and
a distance between each cell of the number of candidate cells and the location of the sensing area.

5. The network entity of claim 4, wherein the at least one processor is further configured to cause the network entity to: identify the at least one cell from the number of candidate cells based on the sensing area indication, the QoS requirements, and the cell-related information.

6. The network entity of claim 1,
wherein the at least one processor is further configured to cause the network entity to: transmit, to a location management function (LMF), a request message to request the cell-related information, wherein the request message includes:
a location of the sensing area; and
a number of candidate cells associated with the sensing area; and
receive, from the LMF, the cell-related information, wherein the cell-related information includes:
a cell identity (ID) of each cell of the number of candidate cells; and
a distance between each cell of the number of candidate cells and the location of the sensing area.

7. The network entity of claim 6, wherein the at least one processor is further configured to cause the network entity to: identify the at least one cell from the number of candidate cells based on the sensing area indication, the QoS requirements, and the cell-related information.

8. The network entity of claim 1, wherein the cell-related information is stored in the network entity, and wherein the cell-related information includes cell identities of one or more cells and positions of the one or more cells.

9. The network entity of claim 1, wherein the at least one processor is further configured to cause the network entity to: transmit an indication to an AMF, wherein the indication includes a cell identity (ID) of the at least one cell and expected radio resources for performing the sensing operation.

10. The network entity of claim 1,
wherein the at least one processor is further configured to cause the network entity to: receive sensing data from at least one base station (BS) in the at least one cell via a user plane function (UPF) or a network data analytics function (NWDAF),
analyze the sensing data to generate a sensing result, and
transmit the sensing result to an application function (AF).

11. The network entity of claim 1, wherein the at least one processor is further configured to cause the network entity to: transmit an indication to at least one base station (BS) in the at least one cell to trigger the sensing operation in the at least one cell.

12. The network entity of claim 9, wherein the sensing operation includes at least one of: sensing signal transmission, sensing signal reception, sensing signal pre-processing, or sensing data transmission.

13. The network entity of claim 1, wherein the network entity is a sensing function (SF).

14. The network entity of claim 1, wherein the network entity is an access and mobility management function (AMF).

15. A method performed by a network entity, the method comprising:
receiving a sensing service request, which includes a sensing area indication indicating a sensing area and quality of service (QOS) requirements, to perform a sensing operation; and
identifying, based on the sensing area indication, the QOS requirements, and cell-related information, at least one cell for performing the sensing operation.

16. The method of claim 15, wherein the sensing area indication indicates information to describe the sensing area to be sensed.

17. The method of claim 15, wherein the sensing area indication includes at least a location of the sensing area and a range of the sensing area.

18. The method of claim 15, further comprising: transmitting, to an access and mobility management function (AMF), a request message to request the cell-related information, wherein the request message includes:
a location of the sensing area; and
a number of candidate cells associated with the sensing area; and
receiving, from the AMF, the cell-related information, wherein the cell-related information includes:
a cell identity (ID) of each cell of the number of candidate cells; and
a distance between each cell of the number of candidate cells and the location of the sensing area.

19. The method of claim 15, further comprising:
receiving sensing data from at least one base station (BS) in the at least one cell via a user plane function (UPF) or a network data analytics function (NWDAF),
analyze the sensing data to generate a sensing result, and
transmit the sensing result to an application function (AF).

20. The method of claim 15, wherein the sensing operation includes at least one of: sensing signal transmission, sensing signal reception, sensing signal pre-processing, or sensing data transmission.
